(19) United States
(12) Patent Application Publication
(10) Pub. No.: US 2013/0021374 A1
(43) Pub. Date: Jan. 24, 2013

(54) Manipulating And Displaying An Image On A Wearable Computing System

(71) Applicants: Xiaoyu Miao, Sunnyvale, CA (US); Mitchell Joseph Heinrich, San Francisco, CA (US)

(72) Inventors: Xiaoyu Miao, Sunnyvale, CA (US); Mitchell Joseph Heinrich, San Francisco, CA (US)

(73) Assignee: GOOGLE INC., Mountain View, CA (US)

(21) Appl. No.: 13/291,416

(22) Filed: Nov. 8, 2011

Related U.S. Application Data
(60) Provisional application No. 61/509,833, filed on Jul. 20, 2011.

(51) Int. Cl. G09G 5/00

(52) U.S. Cl. 345/633

(57) ABSTRACT

Example methods and systems for manipulating and displaying a real-time image and/or photograph on a wearable computing system are disclosed. A wearable computing system may provide a view of a real-world environment of the wearable computing system. The wearable computing system may image at least a portion of the view of the real-world environment in real-time to obtain a real-time image. The wearable computing system may receive at least one input command that is associated with a desired manipulation of the real-time image. The at least one input command may be a hand gesture. Then, based on the at least one received input command, the wearable computing system may manipulate the real-time image in accordance with the desired manipulation. After manipulating the real-time image, the wearable computing system may display the manipulated real-time image in a display of the wearable computing system.

### CROSS-REFERENCE TO RELATED APPLICATION

The present disclosure claims priority to U.S. Patent Application No. 61/509,833, filed on Jul. 20, 2011, the entire contents of which are herein incorporated by reference.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. As computers become more advanced, augmented-reality devices, which blend computer-generated information with the user's perception of the physical world, are expected to become more prevalent.

### SUMMARY

In one aspect, an example method involves: (i) a wearable computing system providing a view of a real-world environment of the wearable computing system; (ii) imaging at least a portion of the view of the real-world environment in real-time to obtain a real-time image; (iii) the wearable computing system receiving an input command that is associated with a desired manipulation of the real-time image; (iv) based on the received input command, the wearable computing system manipulating the real-time image in accordance with the desired manipulation; and (v) the wearable computing system displaying the manipulated real-time image in a display of the wearable computing system.

In an example embodiment, the desired manipulation of the image may be selected from the group consisting of zooming in on at least a portion of the real-time image, panning through at least a portion of the real-time image, rotating at least a portion of the real-time image, and editing at least a portion of the real-time image.

In an example embodiment, the method may involve: a wearable computing system providing a view of a real-world environment of the wearable computing system; (i) imaging at least a portion of the view of the real-world environment in real-time to obtain a real-time image; (ii) the wearable computing system receiving at least one input command that is associated with a desired manipulation of the real-time image, wherein the at least one input command comprises an input command that identifies a portion of the real-time image to be manipulated, wherein the input command that identifies the portion of the real-time image to be manipulated comprises a hand gesture detected in a region of the real-world environment, wherein the region corresponds to the portion of the real-time image to be manipulated; (iii) based on the at least one received input command, the wearable computing system manipulating the real-time image in accordance with the desired manipulation; and (iv) the wearable computing system displaying the manipulated real-time image in a display of the wearable computing system.

In another aspect, a non-transitory computer readable medium having instructions stored thereon that, in response to execution by a processor, cause the processor to perform operations is disclosed. According to an example embodiment, the instructions include: (i) instructions for providing a view of a real-world environment of a wearable computing system; (ii) instructions for imaging at least a portion of the view of the real-world environment in real-time to obtain a real-time image; (iii) instructions for receiving an input command that is associated with a desired manipulation of the real-time image; (iv) instructions for, based on the received input command, manipulating the real-time image in accordance with the desired manipulation; and (v) instructions for displaying the manipulated real-time image in a display of the wearable computing system.

In yet another aspect, a wearable computing system is disclosed. An example wearable computing system includes: (i) a head-mounted display, wherein the head-mounted display is configured to provide a view of a real-world environment of the wearable computing system, wherein providing the view of the real-world environment comprises displaying computer-generated information and allowing visual perception of the real-world environment; (ii) an imaging system, wherein the imaging system is configured to image at least a portion of the view of the real-world environment in real-time to obtain a real-time image; (iii) a controller, wherein the controller is configured to (a) receive an input command that is associated with a desired manipulation of the real-time image and (b) based on the received input command, manipulate the real-time image in accordance with the desired manipulation; and (iv) a display system, wherein the display system is configured to display the manipulated real-time image in a display of the wearable computing system.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a first view of a wearable computing device for receiving, transmitting, and displaying data, in accordance with an example embodiment.

FIG. 2 is a second view of the wearable computing device of FIG. 1, in accordance with an example embodiment.

FIG. 3 is a simplified block diagram of a computer network infrastructure, in accordance with an example embodiment.

FIG. 4 is a flow chart illustrating a method according to an example embodiment.

FIG. 5a is an illustration of an example view of a real-world environment of a wearable computing system, according to an example embodiment.

FIG. 5b is an illustration of an example input command for selecting a portion of a real-time image to manipulate, according to an example embodiment.

FIG. 5c is an illustration of an example displayed manipulated real-time image, according to an example embodiment.

FIG. 5d is an illustration of another example displayed manipulated real-time image, according to another example embodiment.

FIG. 6a is an illustration of an example hand gesture, according to an example embodiment.

FIG. 6b is an illustration of another example hand gesture, according to an example embodiment.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method embodiments described herein are not meant to be limiting. It will be readily understood that certain aspects of the disclosed systems and methods can be arranged and combined in a wide variety of different configurations, all of which are contemplated herein.

### I. OVERVIEW

A wearable computing device may be configured to allow visual perception of a real-world environment and to display computer-generated information related to the visual perception of the real-world environment. Advantageously, the computer-generated information may be integrated with a user's perception of the real-world environment. For example, the computer-generated information may supplement a user's perception of the physical world with useful computer-generated information or views related to what the user is perceiving or experiencing at a given moment.

In some situations, it may be beneficial for a user to manipulate the view of the real-world environment. For example, it may be beneficial for a user to magnify a portion of the view of the real-world environment. For instance, the user may be looking at a street sign, but the user may not be close enough to the street sign to clearly read the street name displayed on the street sign. Thus, it may be beneficial for the user to be able to zoom in on the street sign in order to clearly read the street name. As another example, it may be beneficial for a user to rotate a portion of the view of the real-world environment. For example, a user may be viewing something that has text that is either upside down or sideways. In such a situation, it may be beneficial for the user to rotate that portion of the view so that the text is upright.

The methods and systems described herein can facilitate manipulating at least a portion of the user's view of the real-world environment in order to achieve a view of the environment desired by the user. In particular, the disclosed methods and systems may manipulate a real-time image of the real-world environment in accordance with a desired manipulation. An example method may involve: (i) a wearable computing system providing a view of a real-world environment of the wearable computing system; (ii) imaging at least a portion of the view of the real-world environment in real-time to obtain a real-time image; (iii) the wearable computing system receiving an input command that is associated with a desired manipulation of the real-time image; (iv) based on the received input command, the wearable computing system manipulating the real-time image in accordance with the desired manipulation; and (v) the wearable computing system displaying the manipulated real-time image in a display of the wearable computing system.

In accordance with an example embodiment, the wearable computing system may manipulate the real-time image in a variety of ways. For example, the wearable computing system may zoom in on at least a portion of the real-time image, pan through at least a portion of the real-time image, rotate at least a portion of the real-time image, and/or edit at least a portion of the real-time image. By offering the capability of manipulating a real-time image is such ways, the user may beneficially achieve in real time a view of the environment desired by the user.

### II. EXAMPLE SYSTEMS AND DEVICES

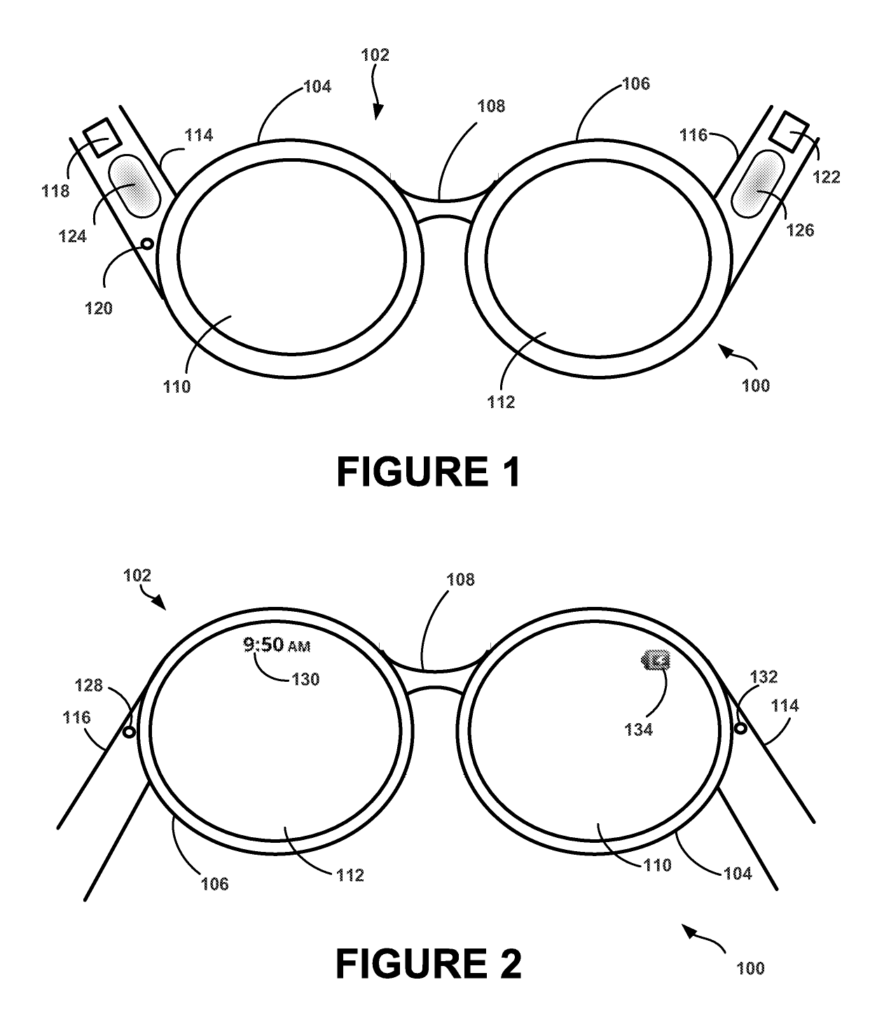

FIG. 1 illustrates an example system 100 for receiving, transmitting, and displaying data. The system 100 is shown in the form of a wearable computing device. While FIG. 1 illustrates eyeglasses 102 as an example of a wearable computing device, other types of wearable computing devices could additionally or alternatively be used. As illustrated in FIG. 1, the eyeglasses 102 comprise frame elements including lens-frames 104 and 106 and a center frame support 108, lens elements 110 and 112, and extending side-arms 114 and 116. The center frame support 108 and the extending side-arms 114 and 116 are configured to secure the eyeglasses 102 to a user's face via a user's nose and ears, respectively. Each of the frame elements 104, 106, and 108 and the extending side-arms 114 and 116 may be formed of a solid structure of plastic and/or metal, or may be formed of a hollow structure of similar material so as to allow wiring and component interconnects to be internally routed through the eyeglasses 102. Each of the lens elements 110 and 112 may be formed of any material that can suitably display a projected image or graphic. In addition, at least a portion of each of the lens elements 110 and 112 may also be sufficiently transparent to allow a user to see through the lens element. Combining these two features of the lens elements can facilitate an augmented reality or heads-up display where the projected image or graphic is superimposed over or provided in conjunction with a real-world view as perceived by the user through the lens elements.

The extending side-arms 114 and 116 are each projections that extend away from the frame elements 104 and 106, respectively, and can be positioned behind a user's ears to secure the eyeglasses 102 to the user. The extending side-arms 114 and 116 may further secure the eyeglasses 102 to the user by extending around a rear portion of the user's head. Additionally or alternatively, for example, the system 100 may connect to or be affixed within a head-mounted helmet structure. Other possibilities exist as well.

The system 100 may also include an on-board computing system 118, a video camera 120, a sensor 122, and finger-operable touch pads 124 and 126. The on-board computing system 118 is shown to be positioned on the extending side-arm 114 of the eyeglasses 102; however, the on-board computing system 118 may be provided on other parts of the eyeglasses 102 or even remote from the glasses (e.g., computing system 118 could be connected wirelessly or wired to eyeglasses 102). The on-board computing system 118 may include a processor and memory, for example. The on-board computing system 118 may be configured to receive and analyze data from the video camera 120, the finger-operable touch pads 124 and 126, the sensor 122 (and possibly from other sensory devices, user-interface elements, or both) and generate images for output to the lens elements 110 and 112.

The video camera 120 is shown positioned on the extending side-arm 114 of the eyeglasses 102; however, the video camera 120 may be provided on other parts of the eyeglasses 102. The video camera 120 may be configured to capture images at various resolutions or at different frame rates. Many video cameras with a small form-factor, such as those used in cell phones or webcams, for example, may be incorporated into an example of the system 100. Although FIG. 1 illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer-generated images appear to interact with the real-world view perceived by the user.

The sensor 122 is shown mounted on the extending side-arm 116 of the eyeglasses 102; however, the sensor 122 may be provided on other parts of the eyeglasses 102. The sensor 122 may include one or more of an accelerometer or a gyroscope, for example. Other sensing devices may be included within the sensor 122 or other sensing functions may be performed by the sensor 122.

The finger-operable touch pads 124 and 126 are shown mounted on the extending side-arms 114, 116 of the eyeglasses 102. Each of finger-operable touch pads 124 and 126 may be used by a user to input commands. The finger-operable touch pads 124 and 126 may sense at least one of a position and a movement of a finger via capacitive sensing, resistance sensing, or a surface acoustic wave process, among other possibilities. The finger-operable touch pads 124 and 126 may be capable of sensing finger movement in a direction parallel or planar to the pad surface, in a direction normal to the pad surface, or both, and may also be capable of sensing a level of pressure applied. The finger-operable touch pads 124 and 126 may be formed of one or more translucent or transparent insulating layers and one or more translucent or transparent conducting layers. Edges of the finger-operable touch pads 124 and 126 may be formed to have a raised, indented, or roughened surface, so as to provide tactile feedback to a user when the user's finger reaches the edge of the finger-operable touch pads 124 and 126. Each of the finger-operable touch pads 124 and 126 may be operated independently, and may provide a different function. Furthermore, system 100 may include a microphone configured to receive voice commands from the user. In addition, system 100 may include one or more communication interfaces that allow various types of external user-interface devices to be connected to the wearable computing device. For instance, system 100 may be configured for connectivity with various hand-held keyboards and/or pointing devices.

FIG. 2 illustrates an alternate view of the system 100 of FIG. 1. As shown in FIG. 2, the lens elements 110 and 112 may act as display elements. The eyeglasses 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110 and 112 may act as a combiner in a light-projection system and may include a coating that reflects the light projected onto them from the projectors 128 and 132. Alternatively, the projectors 128 and 132 could be scanning laser devices that interact directly with the user's retinas.

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in-focus near-to-eye image to the user. A corresponding display driver may be disposed within the frame elements 104 and 106 for driving such a matrix display. Alternatively or additionally, a laser or LED source and scanning system could be used to draw a raster display directly onto the retina of one or more of the user's eyes. Other possibilities exist as well.

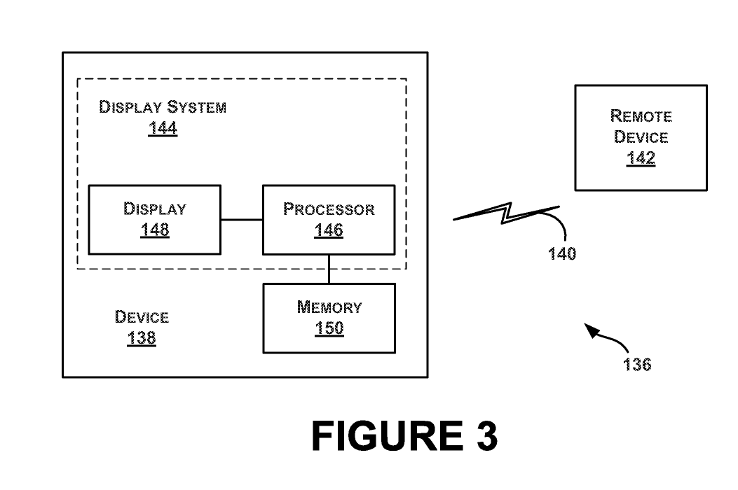

FIG. 3 illustrates an example schematic drawing of a computer network infrastructure. In an example system 136, a device 138 is able to communicate using a communication link 140 (e.g., a wired or wireless connection) with a remote device 142. The device 138 may be any type of device that can receive data and display information corresponding to or associated with the data. For example, the device 138 may be a heads-up display system, such as the eyeglasses 102 described with reference to FIGS. 1 and 2.

The device 138 may include a display system 144 comprising a processor 146 and a display 148. The display 148 may be, for example, an optical see-through display, an optical see-around display, or a video see-through display. The processor 146 may receive data from the remote device 142, and configure the data for display on the display 148. The processor 146 may be any type of processor, such as a micro-processor or a digital signal processor, for example.

The device 138 may further include on-board data storage, such as memory 150 coupled to the processor 146. The memory 150 may store software that can be accessed and executed by the processor 146, for example.

The remote device 142 may be any type of computing device or transmitter including a laptop computer, a mobile telephone, etc., that is configured to transmit data to the device 138. The remote device 142 could also be a server or a system of servers. The remote device 142 and the device 138 may contain hardware to enable the communication link 140, such as processors, transmitters, receivers, antennas, etc.

In FIG. 3, the communication link 140 is illustrated as a wireless connection; however, wired connections may also be used. For example, the communication link 140 may be a wired link via a serial bus such as a universal serial bus or a parallel bus. A wired connection may be a proprietary connection as well. The communication link 140 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 142 may be accessible via the Internet and may, for example, correspond to a computing cluster associated with a particular web service (e.g., social-networking, photo sharing, address book, etc.).

### III. EXEMPLARY METHODS

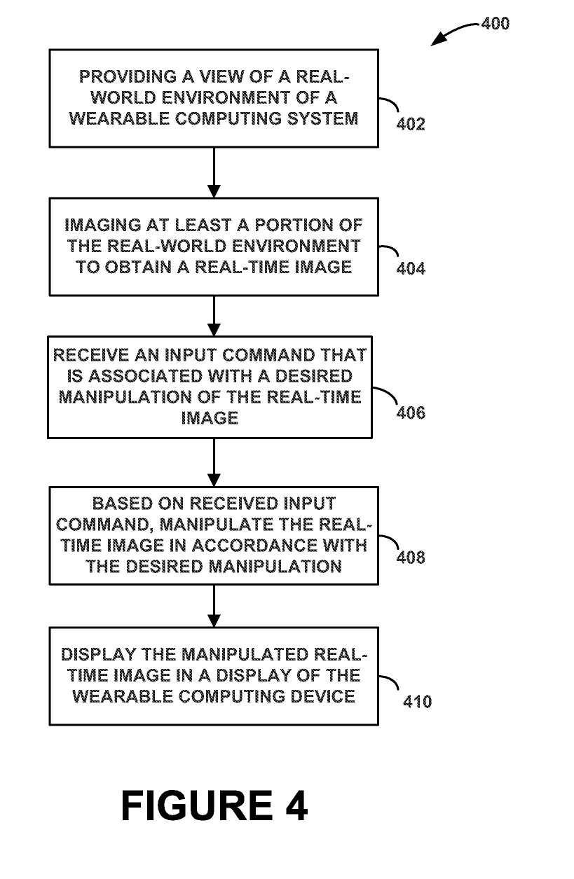

Exemplary methods may involve a wearable computing system, such as system 100, manipulating a user's view of a real-world environment in a desired fashion. FIG. 4 is a flow chart illustrating a method according to an example embodiment. More specifically, example method 400 involves a wearable computing system providing a view of a real-world environment of the wearable computing system, as shown by block 402. The wearable computing system may image at least a portion of the view of the real-world environment in real-time to obtain a real-time image, as shown by block 404. Further, the wearable computing system may receive an input command that is associated with a desired manipulation of the real-time image, as shown by block 406.

Based on the received input command, the wearable computing system may manipulate the real-time image in accordance with the desired manipulation, as shown by block 408. The wearable computing system may then display the manipulated real-time image in a display of the wearable computing system, as shown by block 410. Although the exemplary method 400 is described by way of example as being carried out by the wearable computing system 100, it should be understood that an example method may be carried out by a wearable computing device in combination with one or more other entities, such as a remote server in communication with the wearable computing system.

With reference to FIG. 3, device 138 may perform the steps of method 400. In particular, method 400 may correspond to operations performed by processor 146 when executing instructions stored in a non-transitory computer readable medium. In an example, the non-transitory computer readable medium could be part of memory 150. The non-transitory computer readable medium may have instructions stored thereon that, in response to execution by processor 146, cause the processor 146 to perform various operations. The instructions may include: (i) instructions for providing a view of a real-world environment of a wearable computing system; (ii) instructions for imaging at least a portion of the view of the real-world environment in real-time to obtain a real-time image; (iii) instructions for receiving an input command that is associated with a desired manipulation of the real-time image; (iv) instructions for, based on the received input command, manipulating the real-time image in accordance with the desired manipulation; and (v) instructions for displaying the manipulated real-time image in a display of the wearable computing system

A. Providing a View of a Real-World Environment of the Wearable Computing System

As mentioned above, at block 402 the wearable computing system may provide a view of a real-world environment of the wearable computing system. As mentioned above, with reference to FIGS. 1 and 2, the display 148 of the wearable computing system may be, for example, an optical see-through display, an optical see-around display, or a video see-through display. Such displays may allow a user to perceive a view of a real-world environment of the wearable computing system and may also be capable of displaying computer-generated images that appear to interact with the real-world view perceived by the user. In particular, “see-through” wearable computing systems may display graphics on a transparent surface so that the user sees the graphics overlaid on the physical world. On the other hand, “see-around” wearable computing systems may overlay graphics on the physical world by placing an opaque display close to the user's eye in order to take advantage of the sharing of vision between a user's eyes and create the effect of the display being part of the world seen by the user.

In some situations, it may be beneficial for a user to modify or manipulate at least a portion of the provided view of the real-world environment. By manipulating the provided view of the real-world environment, the user will be able to control the user's perception of the real-world in a desired fashion. A wearable computing system in accordance with an exemplary embodiment, therefore, offers the user functionality that may make the user's view of the real-world more useful to the needs of the user.

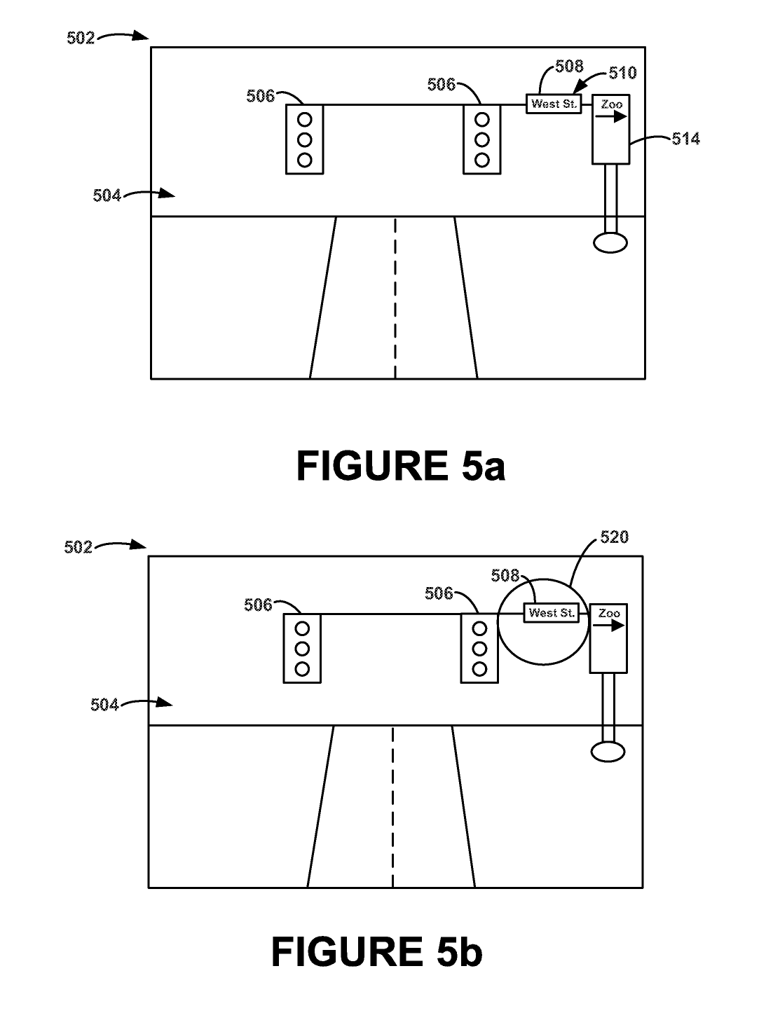

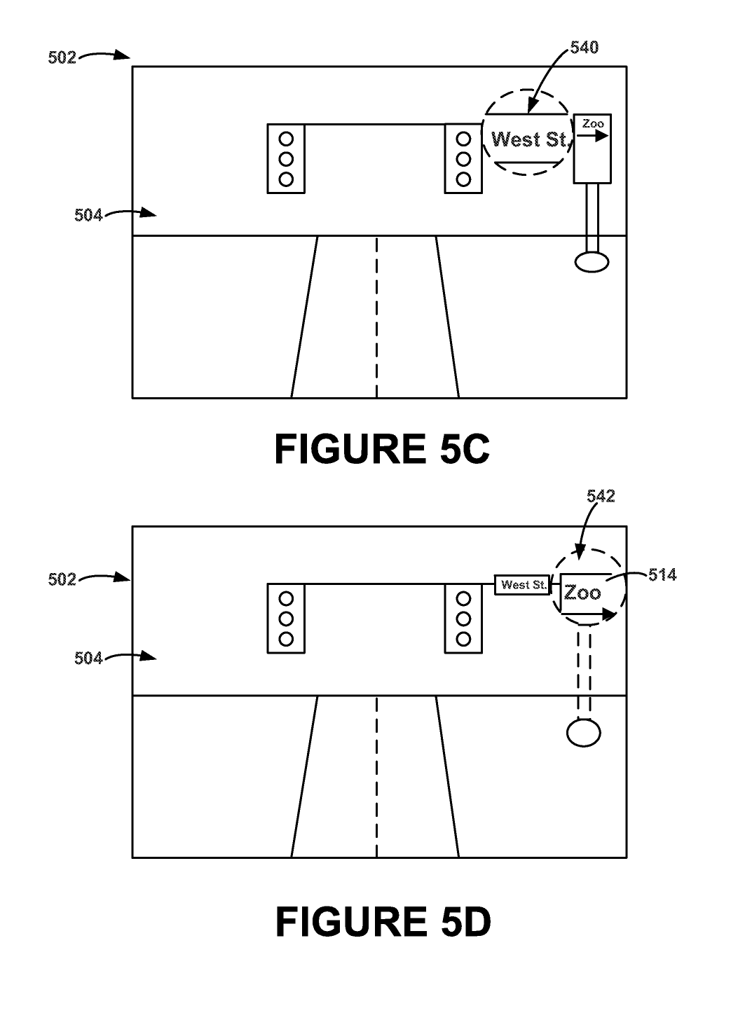

An example provided view 502 of a real-world environment 504 is shown in FIG. 5a. In particular, this example illustrates a view 502 seen by a user of a wearable computing system as the user is driving in a car and approaching a stop light 506. Adjacent to the stop light 506 is a street sign 508. In an example, the street sign may be too far away from the user for the user to clearly make out the street name 510 displayed on the street sign 508. It may be beneficial for the user to zoom in on the street sign 508 in order to read what street name 510 is displayed on the street sign 508. Thus, in accordance with an exemplary embodiment, the user may enter an input command or commands to instruct the wearable computing system to manipulate the view so that the user can read the street name 510. Example input commands and desired manipulations are described in the following subsection.

B. Obtaining a Real-Time Image of at Least a Portion of the Real-World View, Receiving an Input Command Associated with a Desired Manipulation, and Manipulating the Real-Time Image

In order to manipulate the view of the real-world environment, the wearable computing system may, at block 404, image at least a portion of the view of the real-world environment in real-time to obtain a real-time image. The wearable computing system may then manipulate the real-time image in accordance with a manipulation desired by the user. In particular, at block 406, the wearable computing system may receive an input command that is associated with a desired manipulation of the real-time image, and, at block 408, the wearable computing system may manipulate the real-time image in accordance with the desired manipulation. By obtaining a real-time image of at least a portion of the view of the real-world environment and manipulating the real-time image, the user may selectively supplement the user's view of the real-world in real-time.

In an example, the step 404 of imaging at least a portion of the view of the real-world environment in real-time to obtain a real-time image occurs prior to the user inputting the command that is associated with a desired manipulation of the real-time image. For instance, the video camera 120 may be operating in a viewfinder mode. Thus, the camera may continuously be imaging at least a portion of the real-world environment to obtain the real-time image, and the wearable computing system may be displaying the real-time image in a display of the wearable computing system.

In another example, however, the wearable computing system may receive the input command that is associated with a desired manipulation (e.g., zooming in) of the real-time image prior to the wearable computing system imaging at least a portion of the view of the real-world environment in real-time to obtain the real-time image. In such an example, the input command may initiate the video camera operating in viewfinder mode to obtain the real-time image of at least a portion of the of the view of the real-world environment. The user may indicate to the wearable computing system what portion of the user's real-world view 502 the user would like to manipulate. The wearable computing system may then determine what the portion of the real-time image that is associated with the user's real-world view.

In another example, the user may be viewing the real-time image (e.g., the viewfinder from the camera may be displaying the real-time image to the user). In such a case, the user could instruct the wearable computing system which portion of the real-time image the user would like to manipulate.

The wearable computing system may be configured to receive input commands from a user that indicate the desired manipulation of the image. In particular, the input command may instruct the wearable computing system how to manipulate at least a portion the user's view. In addition, the input command may instruct the wearable computing system what portion of the view the user would like to manipulate the view. In an example, a single input command may instruct the wearable computing system both (i) what portion of the view to manipulate and (ii) how to manipulate the identified portion. However, in another example, the user may enter a first input command to identify what portion of the view to manipulate and a second input command to indicate how to manipulate the identified portion. The wearable computing system may be configured to receive input commands from a user in a variety of ways, examples of which are discussed below.

i. Example Touch-Pad Input Commands

In an example, the user may enter the input command via a touch pad of the wearable computing system, such as touch pad 124 or touch pad 126. The user may interact with the touch pad in various ways in order to input commands for manipulating the image. For example, the user may perform a pinch-zoom action on the touch pad to zoom in on the image. The video camera may be equipped with both optical and digital zoom capability, which the video camera can utilize in order to zoom in on the image.

In an example, when a user performs a pinch zoom action, the wearable computing system zooms in towards the center of the real-time image a given amount (e.g., 2× magnification, 3× magnification, etc.). However, in another example, rather than zooming in towards the center of the image, the user may instruct the system to zoom in toward a particular portion of the real-time image. A user may indicate a particular portion of the image to manipulate (e.g., zoom in) in a variety of ways, and examples of indicating what portion of an image to manipulate are discussed below.

As another example touch-pad input command, the user may make a spinning action with two fingers on the touch pad. The wearable computing system may equate such an input command with a command to rotate the image a given number of degrees (e.g., a number of degrees corresponding to the number of degrees of the user's spinning of the fingers). As another example touch-pad input command, the wearable computing system could equate a double tap on the touch pad with a command to zoom in on the image a predetermined amount (e.g., 2× magnification). As yet another example, the wearable computing system could equate a triple tap on the touch pad with a command to zoom in on the image another predetermined amount (e.g., 3× magnification).

ii. Example Gesture Input Commands

In another example, the user may input commands to manipulate an image by using a given gesture (e.g., a hand motion). Therefore, the wearable computing system may be configured to track gestures of the user. For instance, the user may make hand motions in front of the wearable computing system, such as forming a border around an area of the real-world environment. For instance, the user may circle an area the user would like to manipulate (e.g., zoom in on). After circling the area, the wearable computing system may manipulate the circled area in the desired fashion (e.g., zoom in on the circled area a given amount). In another example, the user may form a box (e.g., a rectangular box) around an area the user would like to manipulate. The user may form a border with a single hand or with both hands. Further, the border may be a variety of shapes (e.g., a circular or substantially circular border; a rectangular or substantially rectangular border; etc.).

In order to detect gestures of a user, the wearable computing system may include a gesture tracking system. In accordance with an embodiment, the gesture tracking system could track and analyze various movements, such as hand movements and/or the movement of objects that are attached to the user's hand (e.g., an object such as a ring) or held in the user's hand (e.g., an object such as a stylus).

The gesture tracking system may track and analyze gestures of the user in a variety of ways. In an example, the gesture tracking system may include a video camera. For instance, the gesture tracking system may include video camera 120. Such a gesture tracking system may record data related to a user's gestures. This video camera may be the same video camera as the camera used to capture real-time images of the real world. The wearable computing system may analyze the recorded data in order to determine the gesture, and then the wearable computing system may identify what manipulation is associated with the determined gesture. The wearable computing system may perform an optical flow analysis in order to track and analyze gestures of the user. In order to perform an optical flow analysis, the wearable computing system may analyze the obtained images to determine whether the user is making a hand gesture. In particular, the wearable computing system may analyze image frames to determine what is and what is not moving in a frame. The system may further analyze the image frames to determine the type (e.g., shape) of hand gesture the user is making. In order to determine the shape of the hand gesture, the wearable computing system may perform a shape recognition analysis. For instance, the wearable computing system may identify the shape of the hand gesture and compare the determined shape to shapes in a database of various hand-gesture shapes.

In another example, the hand gesture detection system may be a laser diode detection system. For instance, the hand-gesture detection system may be a laser diode system that detects the type of hand gesture based on a diffraction pattern. In this example, the laser diode system may include a laser diode that is configured to create a given diffraction pattern. When a user performs a hand gesture, the hand gesture may interrupt the diffraction pattern. The wearable computing system may analyze the interrupted diffraction pattern in order to determine the hand gesture. In an example, sensor 122 may comprise the laser diode detection system. Further, the laser diode system may be placed at any appropriate location on the wearable computing system.

Alternatively, the hand-gesture detection system may include a closed-loop laser diode detection system. Such a closed-loop laser diode detection system may include a laser diode and a photon detector. In this example, the laser diode may emit light, which may then reflect off a user's hand back to the laser diode detection system. The photon detector may then detect the reflected light. Based on the reflected light, the system may determine the type of hand gesture.

In another example, the gesture tracking system may include a scanner system (e.g., a 3D scanner system having a laser scanning mirror) that is configured to identify gestures of a user. As still yet another example, the hand-gesture detection system may include an infrared camera system. The infrared camera system may be configured to detect movement from a hand gesture and may analyze the movement to determine the type of hand gesture.

As a particular manipulation example, with reference to FIG. 5b, the user may desire to zoom in on the street sign 508 in order to obtain a better view of the street name 510 displayed in the street sign 508. The user may make a hand gesture to circle area 520 around street sign 508. The user may make this circling hand gesture in front of the wearable computer and in the user's view of the real-world environment. As discussed above, the wearable computing system may then image or may already have an image of at least a portion of the real-world environment that corresponds to the area circled by the user. The wearable computing system may then identify an area of the real-time image that corresponds to the circled area 520 of view 502. The computing system may then zoom in on the portion of the real-time image and display the zoomed in portion of the real-time image. For example, FIG. 5c shows the displayed manipulated (i.e., zoomed) portion 540. The displayed zoomed portion 540 shows the street sign 508 in great detail, so that the user can easily read the street name 510.

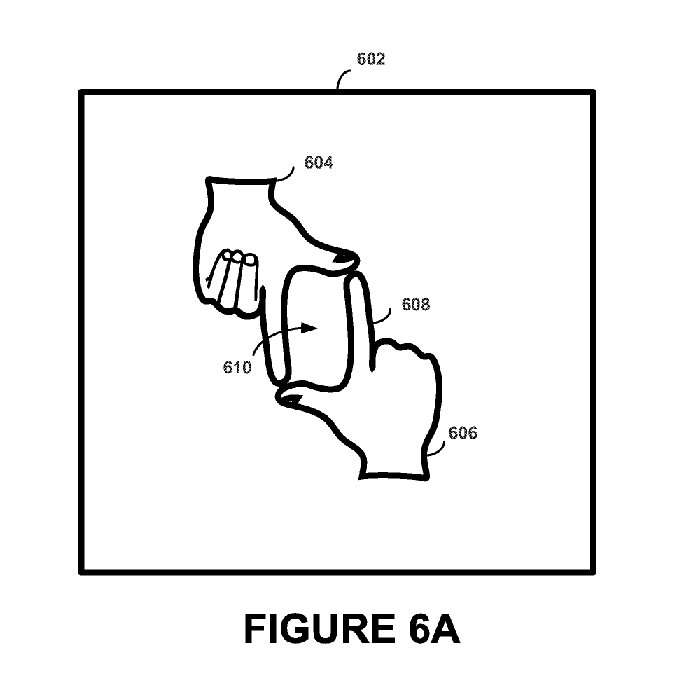

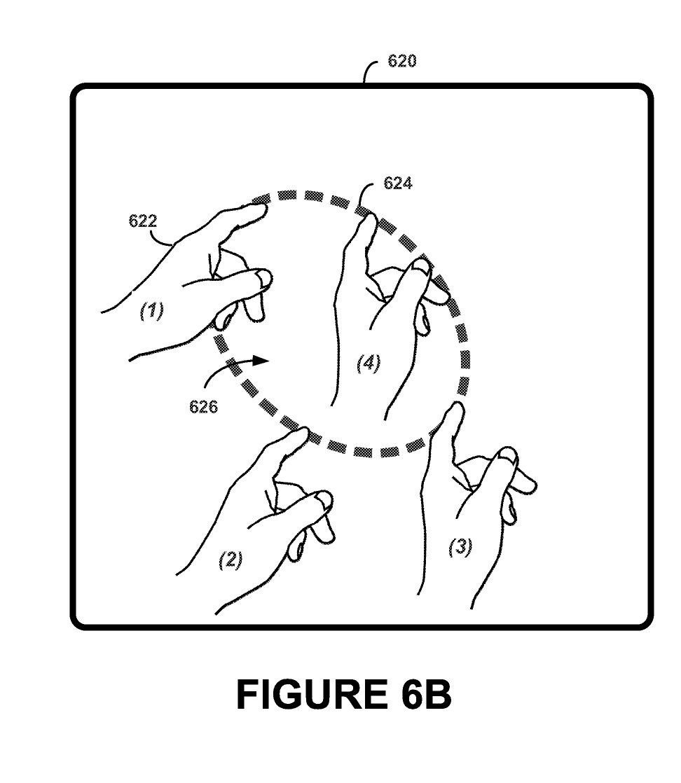

In an example, circling the area 520 may be an input command to merely identify the portion of the real-world view or real-time image that the user would like to manipulate. The user may then input a second command to indicate the desired manipulation. For example, after circling the area 520, in order to zoom in on portion 520, the user could pinch zoom or tap (e.g., double tap, triple tap, etc) the touch pad. In another example, the user could input a voice command (e.g., the user could say “Zoom”) to instruct the wearable computing system to zoom in on area 520. On the other hand, in another example, the act of circling area 520 may serve as an input command that indicates both (i) what portion of the view to manipulate and (ii) how to manipulate the identified portion. For example, the wearable computing system may treat a user circling an area of view as a command to zoom into the circled area. Other hand gestures may indicate other desired manipulations. For instance, the wearable computing system may treat a user drawing a square around a given area as a command to rotate the given area 90 degrees. Other example input commands are possible as well. FIGS. 6a and 6b depict example hand gestures that may be detected by the wearable computing system. In particular, FIG. 6a depicts a real-world view 602 were a user is making a hand gesture with hands 604 and 606 in a region of the real-world environment. The hand gesture is a formation of a rectangular box, which forms a border 608 around a portion 610 of the real-world-environment. Further, FIG. 6b depicts a real-world view 620 were a user is making a hand gesture with hand 622. The hand gesture is a circling motion with the user's hand 622 (starting at position (1) and moving towards position (4)), and the gesture forms an oval border 624 around a portion 626 of the real-world-environment. In these examples, the formed border surrounds an area in the real-world environment, and the portion of the real-time image to be manipulated may correspond to the surrounded area. For instance, with reference to FIG. 6a, the portion of the real-time image to be manipulated may correspond to the surrounded area 610. Similarly, with reference to FIG. 6b, the portion of the real-time image to be manipulated may correspond to the surrounded area 626.

As mentioned above, the hand gesture may also identify the desired manipulation. For example, the shape of the hand gesture may indicate the desired manipulation. For instance, the wearable computing system may treat a user circling an area of view as a command to zoom into the circled area. As another example, the hand gesture may be a pinch-zoom hand gesture. The pinch zoom hand gesture may serve to indicate both the area on which the user would like to zoom in and that the user would like to zoom in on the area. As yet another example, the desired manipulation may be panning through at least a portion of the real-time image. In such a case, the hand gesture may be a sweeping hand motion, where the sweeping hand motion identifies a direction of the desired panning The sweeping hand gesture may comprise a hand gesture that looks like a two-finger scroll. As still yet another example, the desired manipulation may be rotating a given portion of the real-time image. In such a case, the hand gesture may include (i) forming a border around an area in the real-world environment, wherein the given portion of the real-time image to be manipulated corresponds to the surrounded area and (ii) rotating the formed border in a direction of the desired rotation. Other example hand gestures to indicate the desired manipulation and/or the portion of the image to be manipulated are possible as well.

iii. Determining an Area Upon which a User is Focusing

In another example embodiment, the wearable computing system may determine which area of the real-time image to manipulate by determining the area of the image on which the user is focusing. Thus, the wearable computing system may be configured to identify an area of the real-world view or real-time image on which the user is focusing. In order to determine what portion of the image on which a user is focusing, the wearable computing system may be equipped with an eye-tracking system. Eye-tracking systems capable of determining an area of an image the user is focusing on are well-known in the art. A given input command may be associated with a given manipulation of an area the user is focusing on. For example, a triple tap on the touch pad may be associated with magnifying an area the user is focusing on. As another example, a voice command may be associated with a given manipulation on an area the user is focusing on.

iv. Example Voice Input Commands

In yet another example, the user may identify the area to manipulate based on a voice command that indicates what area to manipulate. For example, with reference to FIG. 5a, the user may simply say “Zoom in on the street sign.” The wearable computing system, perhaps in conjunction with an external server, could analyze the real-time image (or alternatively a still image based on the real-time image) to identify where the street sign is in the image. After identifying the street sign, the system could manipulate the image to zoom in on the street sign, as shown in FIG. 5c.

In an example, it may be unclear what area to manipulate based on the voice command. For instance, there may be two or more street signs that the wearable computing system could zoom in on. In such an example, the system could zoom into both street signs. Alternatively, in another example, the system could send a message to the user to inquire which street sign on which the user would like to zoom.

v. Example Remote-Device Input Commands

In still yet another example, a user may enter input commands to manipulate the image via a remote device. For instance, with respect to FIG. 3, a user may use remote device 142 to perform the manipulation of the image. For example, remote device 142 may be a phone having a touchscreen, where the phone is wirelessly paired to the wearable computing system. The remote device 142 may display the real-time image, and the user may use the touchscreen to enter input commands to manipulate the real-time image. The remote device and/or the wearable computing system may then manipulate the image in accordance with the input command(s). After the image in manipulated, the wearable computing system and/or the remote device may display the manipulated image. In addition to a wireless phone, other example remote devices are possible as well.

It should be understood that the above-described input commands and methods for tracking or identifying input commands are intended as examples only. Other input commands and methods for tracking input commands are possible as well.

C. Displaying the Manipulated Image in a Display of the Wearable Computing System

After manipulating the real-time image in the desired fashion, the wearable computing device may display the manipulated real-time image in a display of the wearable computing system, as shown at block 410. In an example, the wearable computing system may overlay the manipulated real-time image over the user's view of the real-world environment. For instance, FIG. 5c depicts the displayed manipulated real-time image 540. In this example, the displayed manipulated real-time image is overlaid over the street sign 510. In another example, the displayed manipulated real-time image may be overlaid over another portion of the user's real-world view, such as in the periphery of the user's real-world view.

D. Other Example Manipulations of the Real-Time Image

In addition to zooming in on a desired portion of an image, other manipulations of the real-time image are possible as well. For instance, other example possible manipulations include panning an image, editing an image, and rotating an image.

For instance, after zooming in on an area of an image, the user may pan the image to see an area surrounding the zoomed-in portion. With reference to FIG. 5a, adjacent to the street sign 508 may be another sign 514 of some sort that the user is unable to read. The user may then instruct the wearable computing system to pan the zoomed-in real-time image 540. FIG. 5d depicts the panned image 542; this panned image 542 reveals the details of the other street sign 514 so that the user can clearly read the text of street sign 514. Beneficially, by panning around the zoomed-in portion, a user would not need to instruct the wearable computing system to zoom back out and then zoom back in on an adjacent portion of the image. The ability to pan images in real-time may thus save the user time when manipulating images in real-time.

In order to pan across an image, a user may enter various input commands, such as a touch-pad input command, a gesture input command, and/or a voice input command. As an example touch-pad input command, a user may make a sweeping motion across the touch pad in a direction the user would like to pan across the image. As an example gesture input command, a user may make a sweeping gesture with the user's hand (e.g., moving finger from left to right) across an area of the user's view that the user would like to pan across. In an example, the sweeping gesture may comprise a two-finger scroll.

As an example voice input command, the user may say aloud “Pan the image.” Further, the user may give specific pan instructions, such as “Pan the street sign”, “Pan two feet to the right”, and “Pan up three inches”. Thus, a user can instruct the wearable computing system with a desired specificity. It should be understood that the above-described input commands are intended as examples only, and other input commands and types of input commands are possible as well.

As another example, the user may edit the image by adjusting the contrast of the image. Editing the image may be beneficial, for example, if the image is dark and it is difficult to decipher details due to the darkness of the image. In order to rotate an image, a user may enter various input commands, such as a touch-pad input command, a gesture input command, and/or a voice input command. For example, the user may say aloud “increase contrast of image.” Other examples are possible as well.

As another example, a user may rotate an image if needed. For instance, the user may be looking at text which is either upside down or sideways. The user may then rotate the image so that the text is upright. In order to rotate an image, a user may enter various input commands, such as a touch-pad input command, a gesture input command, and/or a voice input command. As an example touch-pad input command, a user may make spinning action with the user's fingers on the touch pad. As an example gesture input command, a user may identify an area to rotate, and then make a turning or twisting action that corresponds to the desired amount of rotation. As an example voice input command, the user may say aloud “Rotate image X degrees,” where X is the desired number of degrees of rotation. It should be understood that the above-described input commands are intended as examples only, and other input commands and types of input commands are possible as well.

E. Manipulation and Display of Photographs

In addition to manipulating real-time images and displaying the manipulated real-time images, the wearable computing system may be configured to manipulate photographs and supplement the user's view of the physical world with the manipulated photographs.

The wearable computing system may take a photo of a given image, and the wearable computing system may display the picture in the display of the wearable computing system. The user may then manipulate the photo as desired. Manipulating a photo can be similar in many respects as manipulating a real-time image. Thus, many of the possibilities discussed above with respect to manipulating the real-time image are possible as well with respect to manipulating a photo. Similar manipulations may be performed on streaming video as well.

Manipulating a photo and displaying the manipulated photo in the user's view of the physical world may occur in substantially real-time. The latency when manipulating still images may be somewhat longer than the latency when manipulating real-time images. However, since still images may have a higher resolution than real-time images, the resolution of the still images may beneficially be greater. For an example, if the user is unable to achieve a desired zoom quality when zooming in on a real-time image, the user may instruct the computing system to instead manipulate a photo of the view in order to improve the zoom quality.

### IV. CONCLUSION

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

It should be understood that for situations in which the systems and methods discussed herein collect and/or use any personal information about users or information that might relate to personal information of users, the users may be provided with an opportunity to opt in/out of programs or features that involve such personal information (e.g., information about a user's preferences). In addition, certain data may be anonymized in one or more ways before it is stored or used, so that personally identifiable information is removed. For example, a user's identity may be anonymized so that the no personally identifiable information can be determined for the user and so that any identified user preferences or user interactions are generalized (for example, generalized based on user demographics) rather than associated with a particular user.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
a wearable computing system providing a view of a real-world environment of the wearable computing system;
imaging at least a portion of the view of the real-world environment in real-time to obtain a real-time image;
the wearable computing system receiving at least one input command that is associated with a desired manipulation of the real-time image, wherein the at least one input command comprises an input command that identifies a portion of the real-time image to be manipulated, wherein the input command that identifies the portion of the real-time image to be manipulated comprises a hand gesture detected in a region of the real-world environment, wherein the region corresponds to the portion of the real-time image to be manipulated;
based on the at least one received input command, the wearable computing system manipulating the real-time image in accordance with the desired manipulation; and
the wearable computing system displaying the manipulated real-time image in a display of the wearable computing system.

2. The method of claim 1, wherein the hand gesture further identifies the desired manipulation.

3. The method of claim 1, wherein the hand gesture forms a border.

4. The method of claim 3, wherein the border surrounds an area in the real-world environment, and wherein the portion of the real-time image to be manipulated corresponds to the surrounded area.

5. The method of claim 4, wherein a shape of the hand gesture identifies the desired manipulation.

6. The method of claim 3, wherein the border is selected from the group consisting of a substantially circular border and a substantially rectangular border.

7. The method of claim 1, wherein the hand gesture comprises a pinch-zoom hand gesture.

8. The method of claim 1, wherein the desired manipulation is selected from the group consisting of zooming in on at least a portion of the real-time image, panning through at least a portion of the real-time image, rotating at least a portion of the real-time image, and editing at least a portion of the real-time image.

9. The method of claim 1, wherein the desired manipulation is panning through at least a portion of the real-time image, and wherein the hand gesture comprises a sweeping hand motion, wherein the sweeping hand motion identifies a direction of the desired panning.

10. The method of claim 1, wherein the desired manipulation is rotating a given portion of the real-time image, and wherein the hand gesture comprises (i) forming a border around an area in the real-world environment, wherein the given portion of the real-time image to be manipulated corresponds to the surrounded area and (ii) rotating the formed border in a direction of the desired rotation.

11. The method of claim 1, wherein the wearable computing system receiving at least one input command that is associated with a desired manipulation of the real-time image comprises:
a hand-gesture detection system receiving data corresponding to the hand gesture;
the hand-gesture detection system analyzing the received data to determine the hand gesture.

12. The method of claim 11, wherein the hand-gesture detection system comprises a laser diode system configured to detect the hand gestures.

13. The method of claim 11, wherein the hand-gesture detection system comprises a camera selected from the group consisting of a video camera and an infrared camera.

14. The method of claim 1, wherein the at least one input command further comprises a voice command, wherein the voice command identifies the desired manipulation of the real-time image.

15. The method of claim 1, wherein imaging at least a portion of the view of the real-world environment in real-time to obtain a real-time image comprises a video camera operating in viewfinder mode to obtain a real-time image.

16. The method of claim 1, wherein displaying the manipulated real-time image in a display of the wearable computing system comprises overlaying the manipulated real-time image over the view of a real-world environment of the wearable computing system.

17. A non-transitory computer readable medium having instructions stored thereon that, in response to execution by a processor, cause the processor to perform operations, the instructions comprising:
instructions for providing a view of a real-world environment of a wearable computing system;
instructions for imaging at least a portion of the view of the real-world environment in real-time to obtain a real-time image;
instructions for receiving at least one input command that is associated with a desired manipulation of the real-time image, wherein the at least one input command comprises an input command that identifies a portion of the real-time image to be manipulated, wherein the input command that identifies the portion of the real-time image to be manipulated comprises a hand gesture detected in a region of the real-world environment, wherein the region corresponds to the portion of the real-time image to be manipulated;
instructions for, based on the at least one received input command, manipulating the real-time image in accordance with the desired manipulation; and
instructions for displaying the manipulated real-time image in a display of the wearable computing system.

18. A wearable computing system comprising:
a head-mounted display, wherein the head-mounted display is configured to provide a view of a real-world environment of the wearable computing system, wherein providing the view of the real-world environment comprises displaying computer-generated information and allowing visual perception of the real-world environment;
an imaging system, wherein the imaging system is configured to image at least a portion of the view of the real-world environment in real-time to obtain a real-time image;
a controller, wherein the controller is configured to (i) receive at least one input command that is associated with a desired manipulation of the real-time image and (ii) based on the at least one received input command, manipulate the real-time image in accordance with the desired manipulation, wherein the at least one input command comprises an input command that identifies a portion of the real-time image to be manipulated, wherein the input command that identifies the portion of the real-time image to be manipulated comprises a hand gesture detected in a region of the real-world environment, wherein the region corresponds to the portion of the real-time image to be manipulated; and
a display system, wherein the display system is configured to display the manipulated real-time image in a display of the wearable computing system.

19. The wearable computing system of claim 18, further comprising a hand-gesture detection system, wherein the hand-gesture detection system is configured to detect the hand gestures.

20. The wearable computing system of claim 19, wherein the hand detection system comprises a laser diode.
